(19) United States
(12) Patent Application Publication
(10) Pub. No.: US 2005/0046394 A1
(43) Pub. Date: Mar. 3, 2005

(54) Capacitor-carrying battery, battery apparatus and battery aiding apparatus

(76) Inventor: Koichiro Masumura, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/650,849

(22) Filed: Aug. 29, 2003

(51) Int. Cl. H02J 1/00

(52) U.S. Cl. 320/166

(57) ABSTRACT

A battery, a battery apparatus and a battery aiding apparatus which are capable of lessening a voltage fluctuation of the battery occurring due to the use of an electric equipment system, and which have a high durability, are inexpensively provided. A capacitor-carrying battery provided with a capacitor 2 which is connected to a positive electrode 7 and a negative electrode 8 of the battery, and which is adapted to lessen a voltage drop and a voltage fluctuation of the battery occurring due to the use of a connected electric equipment system 9.

### BACKGROUND OF THE INVENTION

1. FIELD OF THE INVENTION

This invention relates to a battery, a battery apparatus and a battery aiding apparatus, and more particularly to a battery, a battery apparatus and a battery aiding apparatus which are used for a traveling machine, such as an automobile.

2. DESCRIPTION OF THE RELATED ART

A traveling vehicle provided with an internal combustion engine, such as a gasoline engine-carrying automobile is mounted with a battery as a firing device for the combustion of the engine or as a power source. In an ignition system, a momentary high voltage is applied at the time of firing the engine to engine plugs to cause an electric discharge to occur in a clearance therebetween. The hydrocarbon of the gasoline gasified due to the electric discharge is ignited, and the engine is operated by the explosive combustion of the gasoline. At the time the generation of the electric discharge due to this high voltage, a voltage drop and a pulsating and continuous voltage fluctuation usually occur in the battery. A voltage drop and an irregular and continuous voltage fluctuation occur in the battery not only when electric discharge occurs in the ignition system but also when a general electric equipment system is used. This necessarily causes an electric load fluctuation to be continuously applied to a positive electrode and/or a negative electrode of the battery.

However, it is unexpectedly unknown that this phenomenon accelerates the exhaustion of the battery. For example, it is known well that, when an impact, if small, is imparted to a metal continuously, the metal is fatigued and broken. Similarly, when an electric load is applied to a battery continuously for a long period of time, a phenomenon like the gradual accumulation of fatigue encountered in a metal occurs as well but such a phenomenon was liable to be overlooked. Therefore, the fact that such an electric load fluctuation occurring continuously for a long period of time accelerates the exhaustion of the battery has not been taken so seriously. Under the circumstances, a battery capable of lessening the above-mentioned voltage drop and voltage fluctuation ascribed to the use of an electric equipment system has not been devised.

A battery apparatus of a simple construction capable of lessening such voltage drop and voltage fluctuation has not been devised either.

A battery aiding apparatus of a simple construction having such a capability has not been devised either.

The occurrence of such voltage drop and fluctuation as mentioned above not only has a bad influence upon the battery but also causes noise to occur in the electric equipment. Moreover, the electric discharge between the plugs is weakened, so that the torque generated by the engine was also adversely affected.

The electric current passed through the electric equipment system including an ignition system is earthed and returned to a negative electrode of the battery, and the earthing of such an electric current is usually done through a metallic part of a vehicle body in many cases. However, this type of earthing method could not be said to be a suitable earthing method because the metallic part of the vehicle body has a high resistance value, and consumes electric power at a high rate. Therefore, an improvement in an earthing unit was made to a certain extent so as to have the performance of the electric equipment system display sufficiently and so as to heighten the durability of the battery but an apparatus in which a device for lessening a voltage drop and a voltage fluctuation of the battery as mentioned above and an earthing device are combined together has not been devised.

### SUMMARY OF THE INVENTION

Therefore, one of the objects of the present invention is to provide in view of these problems a battery at a low price which is capable of lessening voltage drop and fluctuation, and which has a high durability.

Another object of the present invention is to provide at a low price a battery apparatus capable of bringing out the performance of an electric equipment system with a resistance value of an earthing resistor of the same system held down to a low level, lessening voltage drop and fluctuation of abattery, and heightening the durability of the battery.

Still another object of the present invention is to provide at a low price a simple battery aiding apparatus capable of bringing out the performance of an electric equipment system with a resistance value of an earthing resistor of the same system held down to a low level, lessening voltage drop and fluctuation of a battery, and heightening the durability of the battery.

A first invention is a capacitor-carrying battery adapted to drive an electric equipment system, and provided with a capacitor connected to a positive electrode and a negative electrode of the battery, in which a voltage fluctuation occurring between the positive and negative electrodes of the battery due to the use of the electric equipment system is lessened.

Owing to such a construction, a battery of a high durability can be provided at a low price which is adapted to lessen the voltage drop and fluctuation, which occurs between the positive and negative electrodes of the battery due to the power consumption of the electric equipment system, by an action of the capacitor connected to the battery in parallel with the electric equipment system, and bring out the performance of the electric equipment system by supplying a stable electric current thereto.

A second invention is a battery apparatus provided with a battery for driving an electric equipment system, a capacitor connected to positive and negative electrodes of the battery and adapted to lessen a voltage fluctuation occurring between the positive and negative electrodes of the battery due to the use of the electric equipment system, and an earthing cord extending from at least a part of the electric equipment system and connected directly to the negative electrode of the battery through a wire harness of a resistance value lower than that of a vehicle body.

Owing to such a construction, a battery of a high durability can be provided at a low price which is adapted display the performance of the electric equipment system by the earthing cord of a low resistance value, lessen the voltage drop and fluctuation, which occur between the positive and negative electrodes of the battery due to the power consumption of the electric equipment system, by the capacitor provided in parallel with the electric equipment system, and prevent the consumption of the battery by supplying a stable current thereto.

A third invention is a battery aiding apparatus provided with a capacitor which is connected to a positive electrode and a negative electrode of a battery for driving an electric equipment system, and which is adapted to lessen a voltage fluctuation occurring between the positive and negative electrodes of the battery due to the use of the electric equipment system, and an earthing cord extending from at least a part of the electric equipment system and connected directly to the negative electrode of the battery by a wire harness of a resistance value lower than that of a vehicle body.

Owing to such a construction, a battery aiding apparatus can be inexpensively provided which is adapted to have the performance of the electric equipment system display by the earthing cord of a low resistance value, lessen the voltage drop and fluctuation, which occurs between the positive and negative electrodes of the battery due to the power consumption of the electric equipment system, by connecting the capacitor to the battery in parallel with the electric equipment system, and prevent the exhaustion of the battery by supplying a stable current thereto.

### BRIEF DESCRIPTION OF THE DRAWINGS

Preferred embodiments of the present invention will be described with reference to the accompanying drawings, wherein:

FIG. 1 is a schematic perspective view of a mode of embodiment of the capacitor-carrying battery according to the present invention, and an electric equipment system; and

FIG. 2 is a schematic circuit diagram of the mode of embodiment of the capacitor-carrying battery according to the present invention, and the electric equipment system.

### DESCRIPTION OF THE PREFERRED EMBODIMENTS

A mode of embodiment of the present invention will be described with reference to the drawings.

(Mode of Embodiment 1)

This mode of embodiment 1 is a capacitor-carrying battery for driving an electric equipment system, which is provided with a capacitor connected to a positive electrode and a negative electrode of the battery, and which is adapted to lessen a voltage fluctuation occurring between the positive and negative electrodes of the battery due to the use of the electric equipment system.

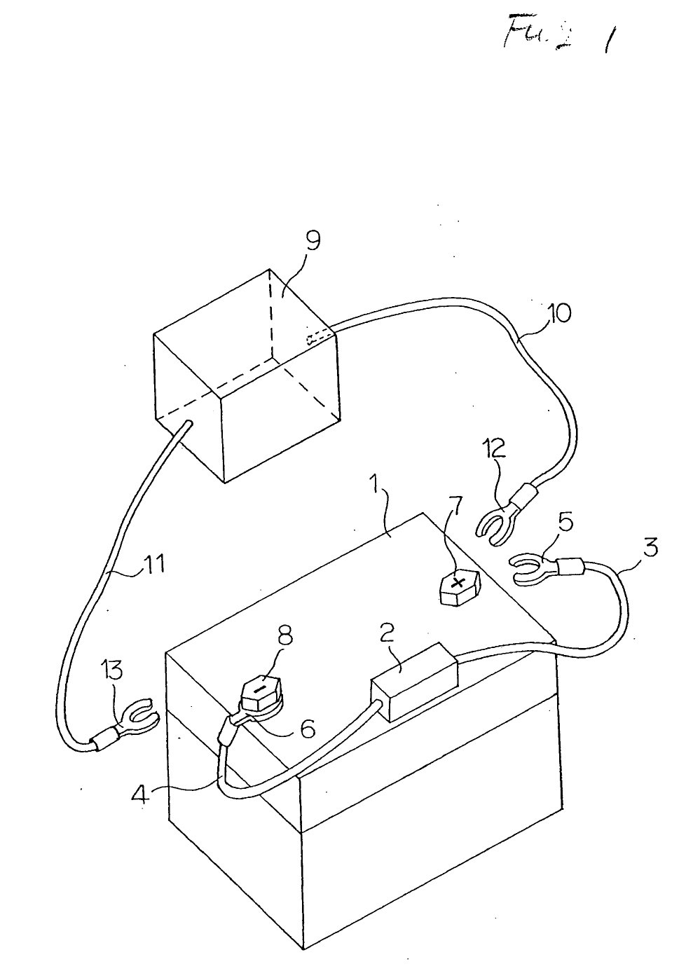

FIG. 1 is a schematic perspective view of a mode of embodiment of the capacitor-carrying battery according to the present invention, and an electric equipment system. A reference numeral 1 denotes a battery body, and 2 a capacitor. Reference numerals 3, 4, 10, 11 denote cords, and 5, 6, 12, 13 connections. A reference numeral 7 denotes a positive electrode, 8 a negative electrode, and 9 an electric equipment system.

The battery 1 is a battery generally used for an internal combustion engine. According to the present invention, the battery is not limited to a battery used for automobiles and a battery used for electric automobiles. Not only a battery for automobiles but also all other types of batteries can be included as long as the batteries have a possibility of receiving during the use thereof a load fluctuation, which occurs due to a voltage drop, from an electric equipment system.

Although the capacitor 2 is provided on an upper portion of a body of the battery 1 in FIG. 1, the capacitor 2 can also be provided in other position. The shape of the capacitor 2 can also be set suitably in accordance with a mode of use thereof, i.e., the capacitor 2 can be made oblong, flat and cylindrical.

The capacitor 2 may also be formed in a cell (not shown) provided in the battery 1 so that the capacitor 2 and the battery 1 are formed in one body. The capacitor 2 may be removable.

The capacity of the capacitor 2 can be set selectively in a suitable manner in accordance with the voltage of the battery, the consumption of the power of the electric equipment system and a voltage drop occurring during the use thereof. The capacity of the capacitor can also be set suitably in accordance with the type of a vehicle or a displacement of an engine.

The cords 3, 4 extending from the capacitor 2 are connected to the positive electrode 7 and negative electrode 8 through the connections 5, 6 respectively. In this embodiment, the capacitor 2 and electric equipment system 9 are connected in parallel with each other to the electrodes of the battery 1. The cords 10, 11 connecting the electric equipment system 9 to the battery 1 are connected to the electrodes 7, 8 through the connections 12, 13.

Owing to such a construction, when static electricity is stored in the capacitor 2, the irregular and continuous voltage drop and fluctuation of the battery 1, which occur due to the use of the electric equipment system 9, can be lessened. This enables a current for the battery to be supplied stably, and the exhaustion of the battery to be prevented. Therefore, a stable current can be sent to the electric equipment system.

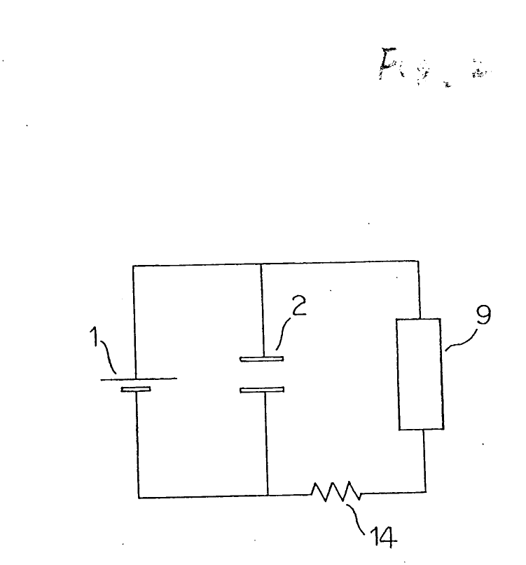

FIG. 2 is a schematic circuit diagram of the mode of embodiment of the capacitor-carrying battery and the electric equipment system according to the present invention. The reference numerals 1, 2 and 9 in this diagram denote the same parts that are represented by the same reference numerals in FIG. 1. A reference numeral 14 denotes an earthing resistor provided between the electric equipment system and the negative electrode.

When an electric current is sent out from the battery 1, the capacitor 2 stores a part of this current therein, and the remaining part of the current is consumed by the electric equipment system 9 and earthing resistor 14. During this time, irregular and continuous voltage drop and fluctuation occur in the battery 1 due to the consumption of power by the electric equipment system, especially, an ignition system. However, since the capacitor 2 is provided in parallel with the electric equipment system, a supply current can be stabilized by making up for the shortage of the power of the battery by the static electricity stored in the capacitor 2.

An electric load imparted to the battery 1 can be weakened by the electricity storage effect of the capacitor 2. When an excessive current flows to the battery due to a certain cause, the capacitor 2 stores at least a part thereof by the electricity storing function thereof. This enables a load on the battery and electric equipment system to be lightened.

In an audio machine out of electric equipment systems 9, a current is stabilized as mentioned above, so that the occurrence of noise can be held down to a low level. Thus, a more stable current can be supplied by lessening the voltage drop and fluctuation, which occur due to the use of the electric equipment system, by making up for the shortage of the power of the battery by the static electricity stored in the capacitor 2. Therefore, the performance of the electric equipment machine can be displayed more satisfactorily.

Especially, when the electric equipment system in this embodiment is an ignition system of an engine, a momentary, high voltage occurs, so that the construction of this mode of embodiment proves more effective.

(Mode of Embodiment 2)

This mode of embodiment 2 is a battery apparatus provided with a battery for driving an electric equipment system, a capacitor connected to a positive electrode and a negative electrode of the battery and adapted to lessen a voltage fluctuation occurring between the positive and negative electrodes of the battery due to the use of the electric equipment system, and an earthing cord extending from at least a part of the electric equipment system and connected directly to the negative electrode of the battery by a wire harness of a resistance value lower than that of a vehicle body.

This mode of embodiment will now be described with reference to FIG. 1 again. The description of the reference numerals is the same as that already given. In this mode of embodiment, a reference numeral 11 denotes an earthing cord extending from the electric equipment system.

In general, an earthing cord of an electric equipment system mounted on a vehicle is connected to a negative electrode by using a metallic portion of a vehicle. Therefore, such an earthing cord has a high resistance value, so that it cannot be said that the conductivity thereof is high. Thus, it cannot be said that the conductivity of the earthing cord becomes high even when the cord is earthed by using a part of a member of a vehicle. Therefore, the performance of the battery and electric equipment system is not necessarily displayed sufficiently in many cases. Under the circumstances, it is conceived that the resistance value of the earthing cord be reduced. A battery apparatus provided with both a device for reducing the resistance value of the earthing cord and a device for lessening voltage drop and fluctuation occurring due to the use of the electric equpment system constitutes this mode of embodiment.

The earthing cord used in this embodiment has a resistance value lower than that of a vehicle body. An earthing cord having such a low resistance value is extended from the electric equipment system and connected directly to the negative electrode of the battery.

Such a capacitor as has already been described can be used for the capacitor used with these parts in this embodiment, a description thereof will be omitted.

Especially, when the electric equipment system in this embodiment is an ignition system of an engine, a momentary high voltage occurs, so that the construction of this mode of embodiment is further effective.

(Mode of Embodiment 3)

The mode of embodiment 3 is a battery aiding apparatus provided with a capacitor connected to a positive electrode and a negative electrode of a battery for driving an electric equipment system and adapted to lessen a voltage fluctuation occurring between the positive and negative electrodes of the battery due to the use of the electric equipment system, and an earthing cord extending from at least a part of the electric equipment system and connected directly to the negative electrode of the battery by a wire harness of a resistance value lower than that of a vehicle body. Namely, this embodiment is a battery aiding apparatus including the same earthing cord of a low resistance value and capacitor as are described in the mode of embodiment 2. Therefore, a detailed description of the third embodiment will be omitted.

Especially, when the electric equipment system in this embodiment is an ignition system of an engine, momentary and voltage drop and fluctuation occur in the battery, so that the construction of this mode of embodiment is further effective.

[Embodiments]

Functional tests on the sense of torque that the driver feels upon the practical traveling were conducted with respect to a case where the same capacitor and earthing cord of a low resistance value as are used in the modes of embodiment of the present invention are provided, a case where such a capacitor only is provided, and a case where neither of such parts is provided. The traveling vehicle used in these cases is the same, i.e. a Legacy Touring Wagon (manufactured by the Subaru Co., Ltd.).

(Embodiment 1)

Such a vehicle as mentioned above with an earthing cord of a low resistance value provided on a battery.

(Embodiment 2)

Such a vehicle as mentioned above with a capacitor provided on a battery.

### Comparative Example

Such a vehicle as mentioned above with neither a capacitor nor an earthing cord of a low resistance value provided on a battery.

The functional data obtained by conducting the traveling tests on these Embodiments 1 and 2 and Comparative Example are shown in Table 1.

TABLE 1

| | | Earthing wore of low | Sense of |
|---|---|---|---|
| | Capacitor | resistance value | torque |
| Embodiment1 | Provided | Provided | ◯◯ |
| Embodiment2 | Provided | Not provided | ◯ |
| Comparative Example | Not provided | Not provided | Δ |

Note:
◯◯: Excellent, ◯: Good, Δ: Ordinary.

As shown in Table 1, the sense of torque was better in Embodiment 2 in which a capacitor only was provided on a battery than that in Comparative Example in which a capacitor was not provided on a battery. It is considered that the reason resides in that a current was stabilized owing to the provision of the capacitor.

The sense of torque was further improved in Embodiment 1in which both a capacitor and an earthing cord of a low resistance value were used, as compared with that in Embodiment 2. It is considered that the reason resides in that the construction provided with the earthing cord of a low resistance value and capacitor caused the effect of the capacitor to be displayed, and also the resistance value of the earthing cord to lower and the current to be further stabilized.

The results of these functional tests proved that the capacitor-carrying battery, battery apparatus and battery aiding apparatus in the modes of embodiment of the present invention had effects of improving the sense of torque.

According to the first invention, a battery of a high durability capable of stabilizing a supply current by lessening the voltage drop and fluctuation, which occur between the positive and negative electrodes of the battery due to the power consumption of an electric equipment system, by a capacitor connected to the battery can be provided at a low price.

According to the second invention, a battery apparatus of a high durability capable of stabilizing a supply current by reducing a resistance value of an earthing cord of an electric equipment system by providing the earthing cord of a low resistance and a capacitor; and lessening voltage drop and fluctuation, which occurs between positive and negative electrodes due to the power consumption of the electric equipment system, by the capacitor can be provided at a low price.

According to the third invention, a battery aiding apparatus capable of improving the durability of a battery by reducing a resistance value of an electric equipment system by combining an earthing cord of a low resistance and a capacitor with each other; and stabilizing a supply current by lessening the voltage drop and fluctuation, which occur between positive and negative electrodes of the battery due to the power consumption of the electric equipment system, by a capacitor, can be provided at a low price.

1. A capacitor-carrying battery for driving an electric equipment system, comprising a capacitor connected to a positive electrode and a negative electrode of the battery, and adapted to lessen a voltage fluctuation occurring between the positive and negative electrodes of the battery due to the use of the electric equipment system.

2. A battery apparatus comprising:
a battery for driving an electric equipment system,
a capacitor connected to a positive electrode and a negative electrode of the battery and adapted to lessen a voltage fluctuation occurring between the positive and negative electrodes of the battery due to the use of the electric equipment system, and
an earthing cord extending from at least a part of the electric equipment system and connected directly to the negative electrode of the battery by a wire harness of a resistance value lower than that of a vehicle body.

3. A battery aiding apparatus comprising:
a capacitor connected to a positive electrode and a negative electrode of a battery for driving an electric equipment system and adapted to lessen a voltage fluctuation occurring between the positive and negative electrodes due to the use of the electric equipment system, and
an earthing cord extending from at least a part of the electric equipment system and connected directly to the negative electrode of the battery by a wire harness of a resistance value lower than that of a vehicle body.
